(19) United States
(12) Patent Application Publication
(10) Pub. No.: US 2012/0217126 A1
(43) Pub. Date: Aug. 30, 2012

(54) COIN DETECTOR

(75) Inventors: Ruei-Jia Huang, Taipei City (TW); Dong-Ying Yang, Taipei City (TW)

(73) Assignee: INTERNATIONAL CURRENCY TECHNOLOGIES CORPORATION, Taipei (TW)

(21) Appl. No.: 13/367,398

(22) Filed: Feb. 7, 2012

(30) Foreign Application Priority Data
Feb. 24, 2011 (TW) 100203328

(51) Int. Cl. G07D 5/00

(52) U.S. Cl. 194/328

(57) ABSTRACT

A coin detector having the characteristics of simple structure, low cost and high recognition speed is disclosed to include a housing defining therein a coin passage, and a circuit module, which uses an optical pickup device consisting of an optical module and an analog-to-digital converter to detect the number and pitch of the parallel lines and grooves of the reeded edge of each inserted coin and a microprocessor to determine the authenticity and value of each inserted coin by means of comparing the data of the sensed number of pitch of parallel lines and grooves with a predetermined reference data.

This application claims the priority benefit of Taiwan patent application number 100203328, filed on Feb. 24, 2011.

### BACKGROUND OF THE INVENTION

1. Field of the Invention

The present invention relates to coin detecting technology and more particularly, to a coin detector, which uses an optical pickup device to detect the number and pitch of the parallel lines and grooves of the reeded edge of each inserted coin so that a microprocessor can determine the authenticity of the sensed coin accurately and rapidly.

2. Description of the Related Art

Following fast development of social civilization and technology, people accelerate their pace of life and require a better quality of life. In consequence, various automatic vending machines are used everywhere to sell different products without serviceman, bringing convenience to people and helping suppliers save much labor cost. Following increasing of selling items, new automatic vending machines with added functions are created.

Further, regular automatic vending machines and game machines commonly use a coin acceptor for receiving coins so that a consumer can insert coins into an automatic vending machine or game machine to purchase commodities or to play games. The coin receiver of a coin-operated machine generally comprises a sensor module for recognizing the authenticity and value of every inserted coin. Because different coins or tokens may be used in different countries or different amusement parks and because different coins/tokens have different sizes and values, a sensor module must be able to recognize the authenticity and values of different coins/tokens. The recognition accuracy of the sensor module is relevant to the subsistence and profit of the business owner and the rights of consumers.

Conventional sensor modules for coin acceptor/coin detector commonly use a non-contact displacement sensor to sense metal coins/tokens. Among conventional non-contact displacement sensors, eddy current sensor is most popularly used for the advantages of small size and operability under a high temperature environment or an environment having a high concentration of dust or pollutants. Subject to the material properties, regular metal coins/tokens can be classified into two groups, namely, the strong magnet group (such as ferrite, copper nickel and the like) and the weak magnet group (such as aluminum, lead, and the like). When an eddy current sensor is electrically connected to generate an oscillation frequency, an AC magnetic field will be produced for sensing different metal materials and for inducing an eddy current upon passing of a metal coin. The distance between the coin and the eddy current sensor, the geometric configuration (size and thickness) of the coin and the magnetic permeability of the material of the coin can cause change of the inductance value of the induced eddy current. Therefore, when a different metal coin passes as the eddy current is generating a constant oscillation frequency, the inductance of the induced eddy current will be different. By means of comparing the inductance of the induced eddy current with a predetermined reference value, the authenticity of the sensed metal coin is recognized.

Subject to the operation principle of the aforesaid eddy current sensing type displacement sensor, it is known that the variation produced upon passing of a metal coin can be expressed by voltage or current. A FM (frequency modulation) circuit is adapted for sensing the variation of the frequency caused by the sensor's equivalent inductance. However, the frequency of a FM circuit is not constant, and the skin depth varies with the frequency of the applied wave. When at a low magnetizing frequency, electrical runout of the metal material of the coin affects the sensing accuracy. Normally, the higher the magnetizing frequency is, the lower the skin depth and the electrical runout will be. However, increasing the magnetizing frequency will complicate the posterior signal processing process, causing increase of the total cost.

Therefore, it is desirable to provide a coin acceptor/detector, which has a simple structure, low manufacturing cost, fast coin authenticity recognition speed and high recognition accuracy.

### SUMMARY OF THE INVENTION

The present invention has been accomplished under the circumstances in view. It is therefore an object of the present invention to provide a coin detector for recognizing the authenticity and value of a coin, which has characteristics of simple structure, low manufacturing cost, fast sensing speed and high recognition accuracy and stability.

To achieve this and other objects of the present invention, a coin detector comprises a housing defining therein a coin passage, and a circuit module mounted inside the housing for detecting the authenticity of each inserted coin. The circuit module comprises an optical pickup device and a microprocessor. The optical pickup device comprises an optical module and an analog-to-digital converter. The optical module comprises a light transmitter adapted to emit light onto the reeded edge of an inserted coin, and a light sensor adapted to pick up reflected light from the reeded edge of the coin and to convert the sensed light signal into a corresponding electric signal. The analog-to-digital converter is adapted to convert the electric signal provided by the light sensor into a corresponding digital signal and then to provide the digital signal to the microprocessor for comparison with a predetermined value for coin authenticity judgment.

Further, the microprocessor determines the number and pitch of parallel lines and grooves of the reeded edge of each coin sensed by the optical pickup device by means of counting the number of pulse digital signals generated by the optical pickup device and measuring the duration of the frequency produced by each pulse digital signal, and then compares the data thus obtained with predetermined reference values for determining the coin authenticity subject to the comparison result.

### BRIEF DESCRIPTION OF THE DRAWINGS

FIG. 1 is an elevational view of a coin detector in accordance with the present invention.

FIG. 2 is an exploded view of the coin detector in accordance with the present invention.

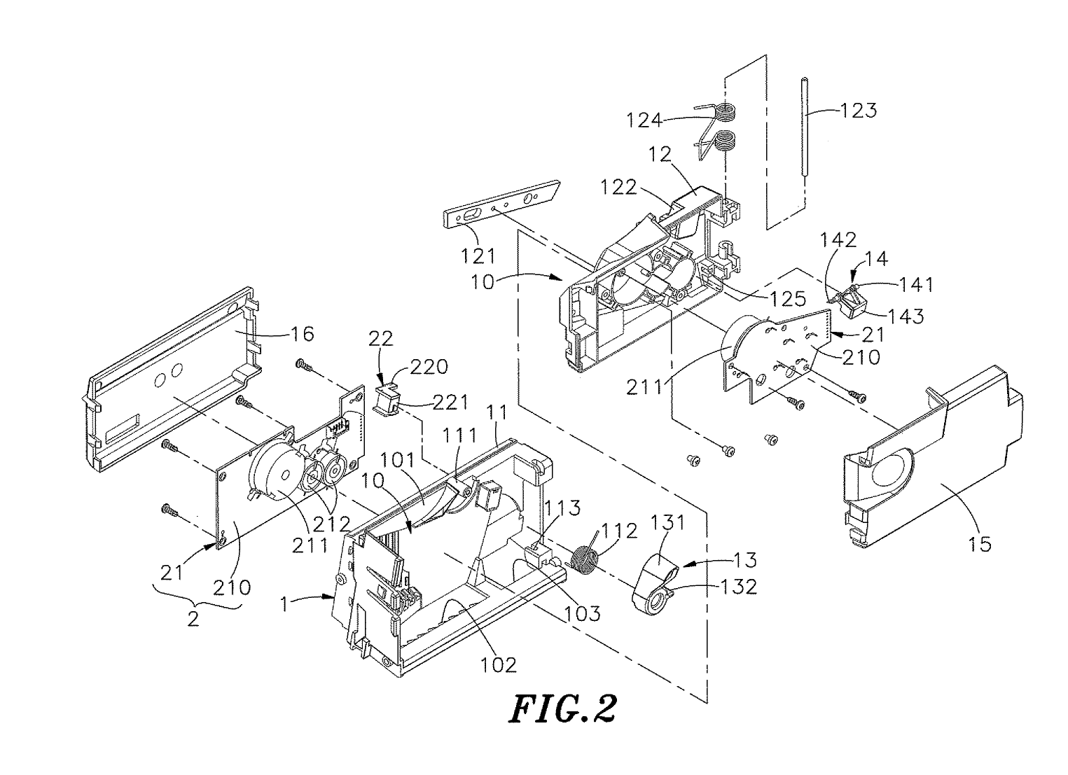

FIG. 3 corresponds to FIG. 2 when viewed from another angle.

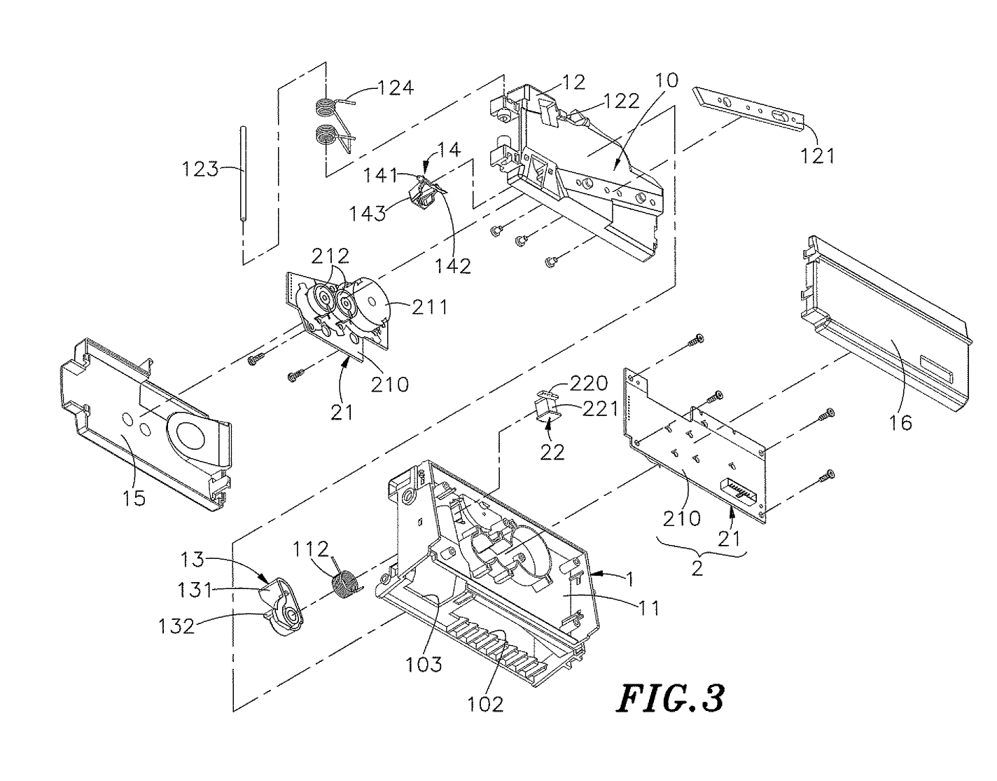

FIG. 4 is a circuit block diagram of the optical pickup device of the circuit module of the coin detector in accordance with the present invention.

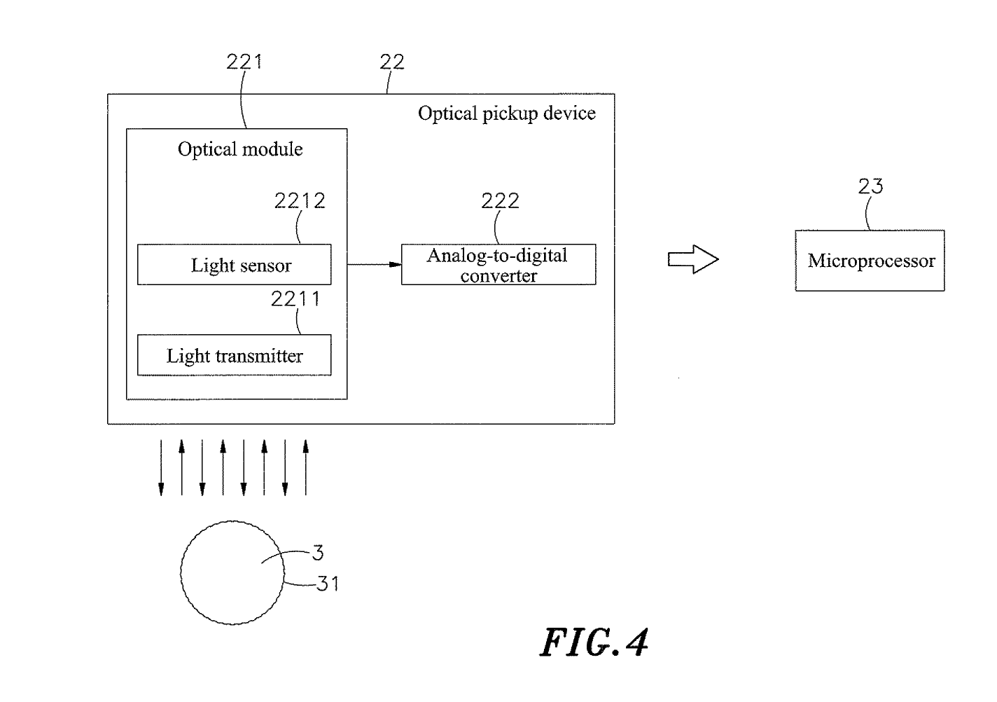

FIG. 5 is an operational flow chart of the present invention.

FIG. 6 is a perspective view, partially cutaway, of the coin detector in accordance with the present invention.

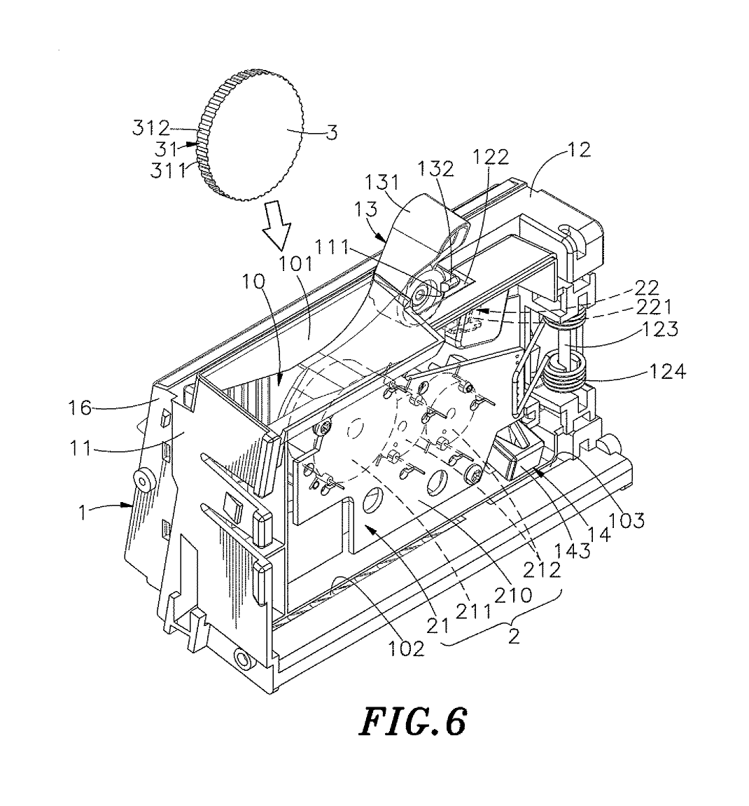

FIG. 7 is a sectional side view of the coin detector in accordance with the present invention.

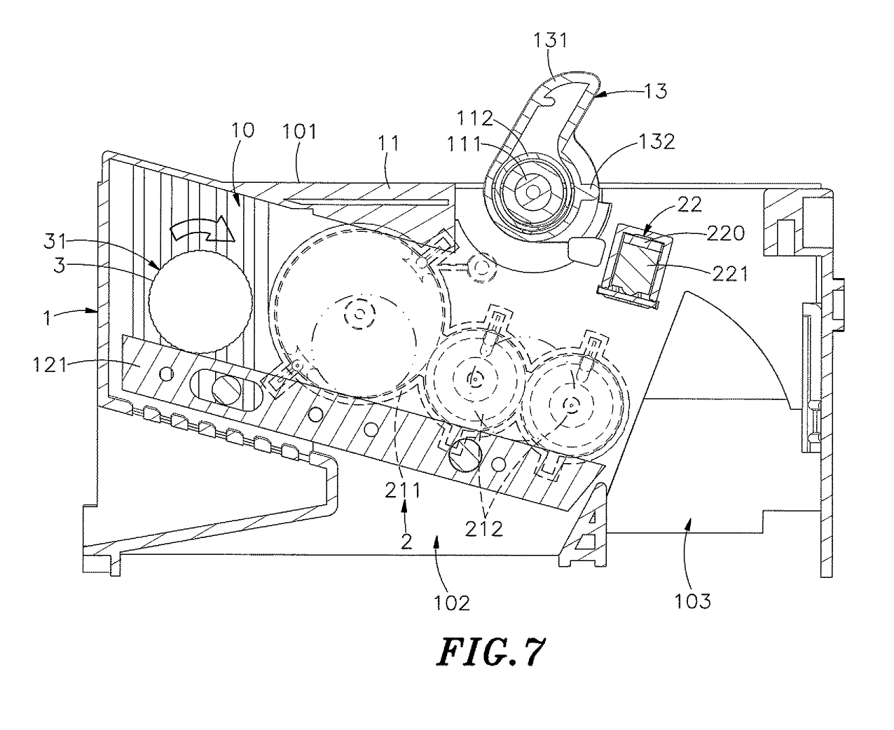

FIG. 8 is a schematic drawing illustrating a sensing status of the optical pickup device in accordance with the present invention.

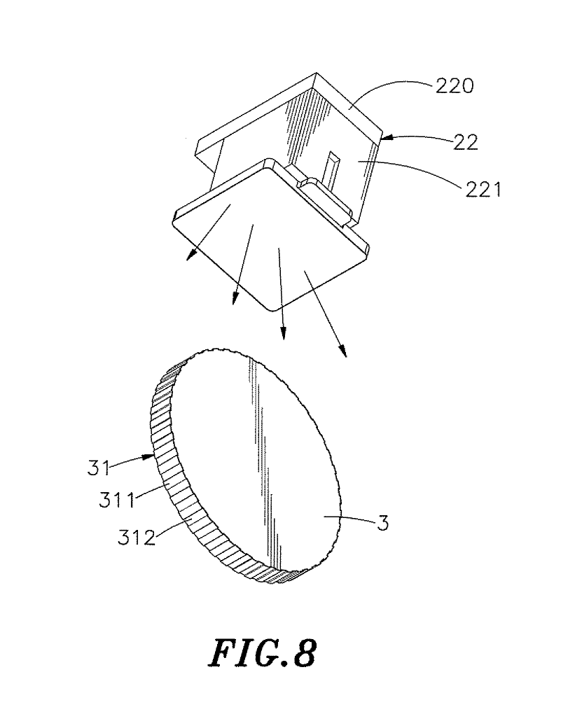

### DETAILED DESCRIPTION OF THE PREFERRED EMBODIMENT

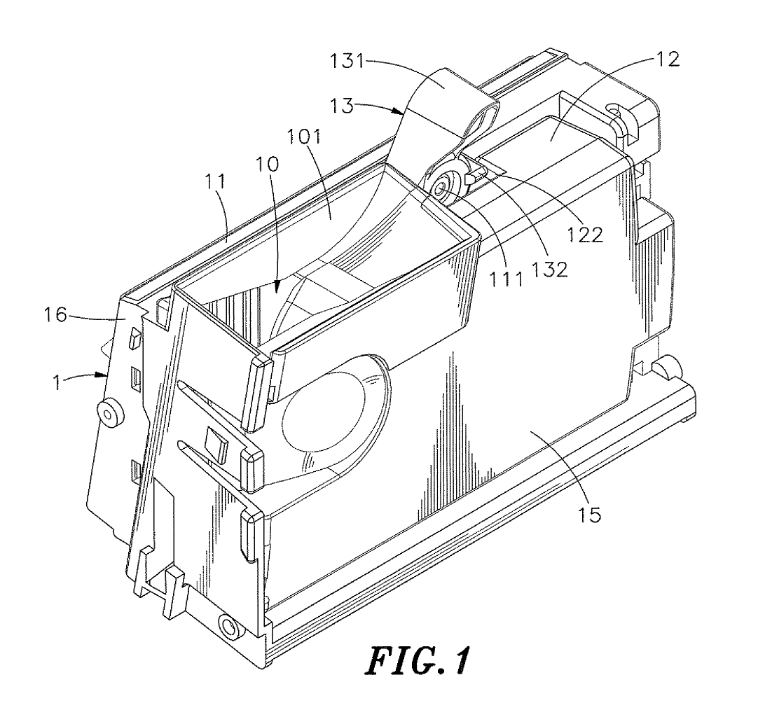

Referring to FIGS. 1˜4, a coin detector in accordance with the present invention is shown comprising a housing 1 and a circuit module 2.

The housing 1 comprises a base frame 11, a partition plate 12 fastened to an inner side of the base frame 11, a coin slot 101 defined in between the base frame 11 and the partition plate 12 at a top side, a coin-return slot 102 and a coin outlet 103 located on a bottom side of the base frame 11 opposite to the coin slot 101 for the insertion of coins 3, a coin passage 10 defined in between the base frame 11 and the partition plate 12 and extending from the coin slot 101 toward the coin-return slot 102 and the coin outlet 103, a pivot 111 transversely disposed at the top side of the base frame 11 adjacent to the coin slot 101, a torsion spring 112 mounted on the pivot 111, a coin-return lever 13 pivotally mounted on the pivot 111 and supported on the torsion spring 112 and operable to move the partition plate 12 relative to the base frame 11, an anti-theft hook 14 rotatably mounted in the coin outlet 103, two axle holes 113 respectively disposed in the rear side of the base frame 11 at different elevations and vertically aligned in line, a first side over 15 fastened to one lateral side of the base frame 11 and a second side cover 16 fastened to an opposite lateral side of the base frame 11 and covered over the partition plate 12.

Further, a guide rail 121 is obliquely mounted in the coin passage 10 for guiding each inserted coin 3 from the coin slot 101 toward the coin outlet 103. Further, the partition plate 12 has a smoothly arched recessed portion 122 located on the top side thereof. The aforesaid coin-return lever 13 comprises a lever body 131 pivotally coupled to the pivot 111 and supported on the torsion spring 112 and a push rod 132 protruded from one end thereof adjacent to the pivot 111 and positioned in the smoothly arched recessed portion 122 of the partition plate 12 for moving the partition plate 12 relative to the base frame 11 upon biasing of the lever body 131. Further, an axle 123 is connected between the two axle holes 113 in the base frame 11 to support a torsion return spring 124 that has multiple legs thereof respectively stopped the base frame 11 and the partition plate 12 and is adapted for returning the partition plate 12 after the partition plate 12 having been moved by the coin-return lever 13 relative to the base frame 11. The aforesaid anti-theft hook 14 comprises a pivot rod 141 pivotally coupled to a pivot holder 125 at the rear bottom side of the partition plate 12 corresponding to the coin outlet 103, a front stop portion 142 disposed at one side relative to the pivot rod 141 and biasable with the pivot rod 141 to stop an inserted coin 3 from backward movement, and a bearing portion 143 disposed at an opposite side relative to the pivot rod 141 and adapted for stopping against the partition plate 12.

The aforesaid circuit module 2 is mounted inside the housing 1, comprising a coin sensor module 21, an optical pickup device 22 and a microprocessor 23. The coin sensor module 21 comprises two circuit boards 210 respectively mounted on the base frame 11 and the partition plate 12 at two opposite lateral sides relative to the coin passage 10. Each circuit board 210 carries a plurality of iron cores 211 and sensing coils 212 facing toward the left or right side of the coin passage 10 for sensing the inductance value of each coin 3 moving through the coin passage 10. The microprocessor 23 is electrically connected to a frequency switching circuit (not shown), and adapted to compare each sensed inductance value with a predetermined reference value for determining the authenticity and value of the respective coin 3. The optical pickup device 22 is mounted in the base frame 11 corresponding to the coin passage 10, comprising a circuit board 220, an optical module 221 installed in the circuit board 220 and an analog-to-digital converter 222 installed in the circuit board 220 and electrically with its input end to the optical module 221 and its output end to the microprocessor 23. The optical module 221 comprises a light transmitter 2211 adapted to emit light onto the reeded edge 31 of a coin 3 moving through the coin passage 10, a light sensor 2212 adapted to pick up reflected light from the reeded edge 31 of the coin 3 and to convert the sensed light signal into a corresponding electric signal, and the analog-to-digital converter 222 adapted to convert the electric signal thus obtained from the light sensor 2212 of the optical module 221 into a corresponding digital signal and then to provide the digital signal to the microprocessor 23 for comparison with a predetermined value for coin authenticity judgment.

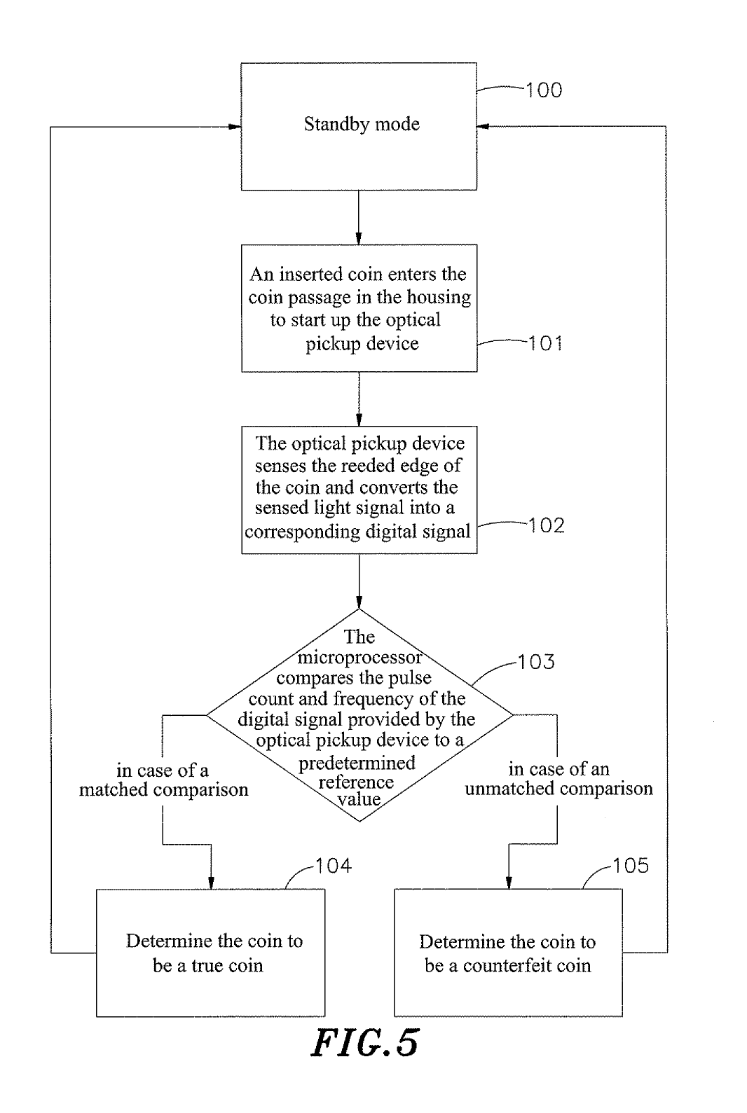

Referring to FIGS. 5˜8, the coin detector can be used in an automatic vending machine, game machine, or any of a variety of other consumer machines that provide commodity purchase services or customer services. After installation of the housing 1 of the coin detector in the automatic vending machine, game machine or consumer machine, the multiple electric connectors of the circuit boards 210; 220 of the circuit module 2 are respectively electrically connected to the main unit of the machine. The microprocessor 23 can be substituted by an equivalent device at the circuit board of the internal control module of the main unit of the machine and electrically coupled with the coin sensor module 21 and the optical pickup device 22. Subject to the functioning of the coin detector, the automatic vending machine, game machine or consumer machine carrying the coin detector can accept coins and detect the authenticity and value of each received coin.

When starting up the optical pickup device 22 to detect the authenticity of a coin 3, the coin detector runs subject to the following steps:
(100) Standby mode.
(101) An inserted coin 3 enters the coin passage 10 in the housing 1 to start up the optical pickup device 22.
(102) The optical pickup device 22 senses the reeded edge 31 of the coin 3 and converts the sensed light signal into a corresponding digital signal.
(103) The microprocessor 23 compares the pulse count and frequency of the digital signal provided by the optical pickup device 22 to a predetermined reference value, and then proceeds to step (104) in case of a matched comparison, or step (105) in case of an unmatched comparison.
(104) Determine the coin to be a true coin, and then return to step (100).
(105) Determine the coin to be a counterfeit coin, and then return to step (100).

As stated above, after a user inserted a coin 3 into the coin slot 101 of the housing 1, the coin 3 moves along the coin passage 10 toward the optical pickup device 22. At this time, the light transmitter 2211 of the optical module 221 emits light through a lens (not shown) onto the reeded edge 31 of the coin 3. During rotation of the coin 3 in the coin passage 10, the parallel lines 311 and grooves 312 of the reeded edge 31 of the coin 3 interfere with the falling light. The light reflected by the reeded edge 31 is then picked up by the light sensor 2212 and converted into a corresponding electric signal. The light sensor 2212 can be a CMOS (complementary metal-oxide semiconductor) sensor, CCD (charge coupled device) sensor or CIS (contact image sensor). The electric signal produced by light sensor 2212 is then converted into a corresponding digital signal by the analog-to-digital converter 222, outputted by the analog-to-digital converter 222 to the microprocessor 23 for comparison with a predetermined reference value for coin authenticity judgment. The number and pitch of the parallel lines 311 and grooves 312 of the reeded edge 31 of the coin 3 are made subject to a predetermined design. By means of counting the number of pulse digital signals and measuring the duration of the frequency produced by each pulse digital signal, the number and pitch of the parallel lines 311 and grooves 312 of the reeded edge 31 are known and compared with the predetermined reference values by the microprocessor 23 for coin authenticity judgment. Further, the reading speed of the optical pickup device 22 is fast, enhancing coin recognition accuracy and stability. When compared to conventional coin sensing devices, the invention has the characteristics of simple structure, low manufacturing cost, fast sensing speed and high recognition accuracy and stability.

When the number and pitch of the parallel lines 311 and grooves 312 of the reeded edge 31 of the sensed coin 3 match the respective predetermined reference values, the coin 3 is determined to be a true coin. At this time, the microprocessor 23 outputs a control signal to an electromagnetic valve to open a gate (not shown), enabling the coin 3 to move along the guide rail 121 to the coin outlet 103 and then to an internal passage in the main unit of the machine toward a coin box. If the number and pitch of the parallel lines 311 and grooves 312 of the reeded edge 31 of the sensed coin 3 do not match the respective predetermined reference values, the coin 3 is determined to be a counterfeit coin. At this time, the aforesaid gate is kept closed, and the counterfeit coin will be guided out of the coin passage 10 to the coin-return slot 102. Further, if the inserted coin 3 is stuck in the coin passage 10, the user can operate the lever body 131 of the coin-return lever 13 to for the push rod 132 against the smoothly arched recessed portion 122 of the partition plate 12 and to further move the partition plate 12 and the guide rail 121 relative to the base frame 11, enabling the coin 3 to fall from the coin passage 10 to the coin-return slot 102.

In conclusion, the invention provides a coin detector, which uses a optical pickup device 22 consisting of an optical module 221 and an analog-to-digital converter 222 for sensing the number and pitch of the parallel lines 311 and grooves 312 of the reeded edge 31 of a coin 3 for enabling a microprocessor 23 to determine the authenticity and value of the coin 3 rapidly and accurately.

It is to be understood that the above-described embodiments of the invention are merely possible examples of implementations, merely set forth for a clear understanding of the principles of the invention, many modifications and enhancements may be made without departing from the spirit and scope of the invention. Accordingly, the invention is not to be limited except as by the appended claims.

What the invention claimed is:

1. A coin detector used in a coin-operated machine for detecting the authenticity and value of a coin, comprising:
a housing defining therein a coin passage;
a circuit module mounted inside said housing, said circuit module comprising an optical pickup device and a microprocessor, said optical pickup device comprising an optical module and an analog-to-digital converter, said optical module comprising a light transmitter adapted to emit light onto the reeded edge of a coin moving through said coin passage, a light sensor adapted to pick up reflected light from the reeded edge of the coin and to convert the sensed light signal into a corresponding electric signal, said analog-to-digital converter being electrically coupled with said light sensor of said optical module and adapted to convert the electric signal provided by said light sensor into a corresponding digital signal and then to provide the digital signal to said microprocessor for comparison with a predetermined value for coin authenticity judgment.

2. The coin detector as claimed in claim 1, wherein said housing comprises a base frame, and a partition plate coupled to one side of said base frame and defining with said base frame a coin slot at a top side of said coin passage; said optical pickup device of said circuit module further comprises a circuit board mounted inside said housing adjacent to said coin slot and carrying said optical module and said analog-to-digital converter.

3. The coin detector as claimed in claim 2, wherein said circuit module further comprises a coin sensor module, said coin sensor module comprising two circuit boards respectively mounted on said base frame and said partition plate at two opposite lateral sides relative to said coin passage and a plurality of iron cores and sensing coils respectively installed in each circuit board of said coin sensor module for sensing the inductance value of each coin moving through said coin passage and providing the sensed signal to said microprocessor for comparison with a predetermined reference value for determining the authenticity and value of the coin.

4. The coin detector as claimed in claim 2, wherein said base frame of said housing comprises a pivot transversely disposed near a top side thereof adjacent to said coin slot, a coin-return slot located on a bottom side thereof, a torsion spring mounted on said pivot, a coin-return lever pivotally mounted on said pivot and supported on said torsion spring and operable to move said partition plate relative to said base frame for enabling an inserted coin to fall from said coin passage to said coin-return slot.

5. The coin detector as claimed in claim 4, wherein said housing further comprises a coin outlet located on a bottom side thereof, a guide rail obliquely mounted in said coin passage for guiding each inserted coin from said coin slot toward said coin outlet and a smoothly arched recessed portion located on a top wall of said partition plate; said coin-return lever comprises a lever body pivotally coupled to said pivot and supported on said torsion spring and a push rod protruded from one end thereof adjacent to said pivot and positioned in said smoothly arched recessed portion at said partition plate for moving said partition plate relative to said base frame upon biasing of said lever body relative to said pivot for enabling an inserted coin to fall from said guide rail to said coin-return slot.

6. The coin detector as claimed in claim 2, wherein said housing further comprises a coin outlet located on a bottom side thereof in communication with said coin passage, and an anti-theft hook rotatably mounted in said coin outlet for letting each inserted coin to pass in one single direction from said coin passage to said coin outlet, said anti-theft hook comprising a pivot rod pivotally coupled to a pivot holder at a rear bottom side of said partition plate corresponding to said coin outlet, a front stop portion disposed at one side relative to said pivot rod and biasable with said pivot rod to stop an inserted coin from backward movement, and a bearing portion disposed at an opposite side relative to said pivot rod and adapted for stopping against said partition plate.

7. The coin detector as claimed in claim 4, wherein said housing further comprises two axle holes respectively disposed in a rear side of said base frame at different elevations and vertically aligned in line, an axle connected between said two axle holes, and a torsion return spring mounted on said axle and having multiple legs thereof respectively stopped said base frame and said partition plate for returning said partition plate after said partition plate having been moved by said coin-return lever relative to said base frame.

8. The coin detector as claimed in claim 1, wherein said microprocessor determines the number and pitch of parallel lines and grooves of the reeded edge of each coin sensed by said optical pickup device by means of counting the number of pulse digital signals generated by said optical pickup device and measuring the duration of the frequency produced by each pulse digital signal, and then compares the data thus obtained with predetermined reference values for determining the coin authenticity subject to the comparison result.

9. The coin detector as claimed in claim 1, wherein said light sensor of said circuit module is selected from the group of CMOS (complementary metal-oxide semiconductor) sensor, CCD (charge coupled device) sensor and CIS (contact image sensor).
